(19) United States
(12) Patent Application Publication
(10) Pub. No.: US 2021/0269291 A1
(43) Pub. Date: Sep. 2, 2021

(54) INTRINSICALLY SAFE CABLE TENSIONING DEVICE

(71) Applicant: Richards Manufacturing Company, Irvington, NJ (US)

(72) Inventors: Christopher Callaghan, Middletown, NY (US); Christopher A. Juillet, Warren, NJ (US)

(73) Assignee: Richards Manufacturing Company, Irvington, NJ (US)

(21) Appl. No.: 17/249,407

(22) Filed: Mar. 1, 2021

Related U.S. Application Data
(60) Provisional application No. 62/983,015, filed on Feb. 28, 2020.

(51) Int. Cl. B66D 1/14; B66D 1/54

(52) U.S. Cl. CPC B66D 1/14; B66D 1/54

(57) ABSTRACT

A system, device, and method for improved cable tensioning of intrinsically safe horizontal cable tensioning. A frame having a worm gear operatively associated with both a moveable shaft and a drum in such a way that in an engaged position a rotational motion applied to the worm gear is transferred to the drum, wherein the moveable shaft is movable between a disengaged position and the engaged position, rotationally locking together the drum and the worm gear so that the drum will not rotate until the rotational motion is applied to the worm gear; and a strap operatively associated with the drum. The strap associates with the cable in need of tensioning.

### CROSS-REFERENCE TO RELATED APPLICATION

This application claims the benefit of priority of U.S. provisional application No. 62/983,015, filed 28 Feb. 2020, the contents of which are herein incorporated by reference.

### BACKGROUND OF THE INVENTION

The present disclosure relates to cable tensioning systems, and more specifically, to an improved cable tensioning device and a system for intrinsically safe cable tensioning.

Cable tensioning devices are used primarily by Electric Utilities and Electric Utility Contractors to place, pull and tension overhead electric conductors on utility poles. Devices currently in use and made by several manufacturers utilize a lever operated ratcheting system, generically referred to in the industry as a “Come Along.”

In conventional systems, the lever operated ratcheting system is directly connected to a rotating drum, which rotates in response to a change in position of the lever. For example, when the lever moves in a first direction, the drum rotates in such a direction (e.g., clockwise or counterclockwise) as to wind up or spool out a first tensioning member (e.g., rope, strap, wire, etc.) affixed about the barrel and configured to wind up or spool out at a first side of the device. The second end of the device is connected to a second tensioning member.

In a typical use case, the second tension member is attached to a fixed point, such as a utility pole, while the first tensioning member is attached to the cable(s) that is being tensioned. As a user moves the lever from a first position to a second position, the first tensioning member winds up, thus causing an increase in the tension of the attached cable(s). Likewise, when a user moves the lever from the second position to the first position, the first tensioning member spools out, thus causing a decrease in the tension of the attached cable(s). In these typical systems, a part called a pawl, which is a mechanical switch, is utilized to lock the lever in place once the desired amount of tension exists in the system. The pawl is typically located in the same plane as the lever.

If such switches are incorrectly placed or if they wear out, the operating lever may swing back and hit the operator with considerable force. As will be appreciated, the amount of required tension on the cable determines the amount of force the operator must apply to the operating lever. If the force required is high and the operator is not securely positioned, the possibility exists that the operator may fall from a high ladder or platform to the ground and sustain serious injury. Further, due to the typical positioning of the pawl (e.g., proximity to the lever), such devices are susceptible to improper usage (e.g., unlocking a lever inadvertently or accidentally) or component wear, which can lead to serious injury as previously discussed.

As can be seen, there is a need for systems and methods for improved cable tensioning devices and systems for intrinsically safe horizontal cable tensioning. Embodiments of the present disclosure are directed to this and other considerations.

### SUMMARY OF THE INVENTION

In one aspect of the present invention, a device for improved cable tensioning for intrinsically safe horizontal cable tensioning, the device includes the following: a frame having a worm gear operatively associated with both a moveable shaft and a drum in such a way that in an engaged position a rotational motion applied to the worm gear is transferred to the drum, wherein the moveable shaft is movable between a disengaged position and the engaged position, rotationally locking together the drum and the worm gear so that the drum will not rotate until the rotational motion is applied to the worm gear.

In another aspect of the present invention, system for improved cable tensioning for intrinsically safe horizontal cable tensioning, the system includes the following: a frame having a worm gear operatively associated with both a moveable shaft and a drum in such a way that in an engaged position a rotational motion applied to the worm gear is transferred to the drum, wherein the moveable shaft is movable between a disengaged position and the engaged position, rotationally locking together the drum and the worm gear so that the drum will not rotate until the rotational motion is applied to the worm gear; and a strap operatively associated with the drum.

In yet another aspect of the present invention, a method for improved cable tensioning for intrinsically safe horizontal cable tensioning, the method includes the following: providing the above-mentioned system; attaching the strap to a cable to be tensioned; and applying said rotational motion to the worm gear.

These and other features, aspects and advantages of the present invention will become better understood with reference to the following drawings, description and claims.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a side or top view of an embodiment of the present invention;

FIG. 2 is a cross-sectional view of the present invention taken along line A-A in FIG. 1, illustrating an engaged position;

FIG. 3 is a side or top view of an embodiment of the present invention;

FIG. 4 is a cross-sectional view of the present invention taken along line A-A in FIG. 3, illustrating a disengaged position;

FIG. 5 is a side or top view, orthogonal to FIGS. 1 and 3, of an embodiment of the present invention;

FIG. 6 is partial detail view illustrating internal components of the embodiment of FIG. 5;

FIG. 7 is a side or top view of an embodiment of the present invention, illustrating circumferential gear engagement;

FIG. 8 is a cross-sectional view of the present invention taken along line A-A in FIG. 7, illustrating an engaged position;

FIG. 9 is a side or top view of an embodiment of the present invention, illustrating circumferential gear disengagement;

FIG. 10 is a cross-sectional view of the present invention taken along line B-B in FIG. 9, illustrating a disengaged position;

FIG. 11 is a side or top view, orthogonal to FIGS. 7 and 9, of an embodiment of the present invention; and

FIG. 12 is cross-sectional view of the present invention taken along line C-C in FIG. 11.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Embodiments of the present disclosure provide an intrinsically safe cable tensioning device. The device may include a frame, which may be comprised of a sturdy light weight material, such as, for example aluminum. Within the frame, the device may include a drum, around which a rope or strap may be wound. Adjacent to the drum, along the same axis of rotation, is a circumferential gear. Also, within the frame, the device may include a worm gear which may be in direct contact with the circumferential gear. The worm gear may be a high drag worm gear capable of operating at a high gear ratio. The worm gear may be coupled to an input shaft. The input shaft may include outer ends that protrude from opposing sides of the frame. The outer ends of the input power shaft are equipped with attachment pieces. The attachment pieces may include a square head of a size commonly used in the utility industry or, alternatively, a hex head or other attachment mechanism that allows transfer of rotational motion to the input shaft. A manual hand crank may be removably attachable to the attachment pieces. The removable hand crank permits manual operation or, when removed, a battery powered drill may be used for powered operation of the device.

The circumferential gear and the drum can be rotationally coupled to a moveable shaft. The circumferential gear and the drum may include a matching bore such that the circumferential gear and the drum rotate with the moveable shaft. For example, the matching bore may define a hex shape, a spline, a square shape, or any shape that allows the transfer of rotational motion from the moveable shaft to the circumferential gear and the drum. The moveable shaft has a shape to fit within the matching bores and is capable of sliding along the axis of rotation relative to the drum and the circumferential gear. A spring-loaded pin allows the shaft to be held in either an engaged or a disengaged position. The engaged position is when the moveable shaft is engaging both the drum and circumferential gear together. In this case the worm gear and drum are rotationally locked together and the drum will not rotate until the worm gear is rotated via the input shaft. There are situations when the strap needs to be quickly payed out when there is no load. In this case, the spring-loaded pin is released allowing the moveable shaft to be moved along the axis of rotation to disengage from the circumferential gear. The drum is then able to spin independent of the circumferential gear.

Reference will now be made in detail to example embodiments of the disclosed technology, examples of which are illustrated in the accompanying drawings and disclosed herein. Wherever convenient, the same references numbers may be used throughout the drawings to refer to the same or like parts.

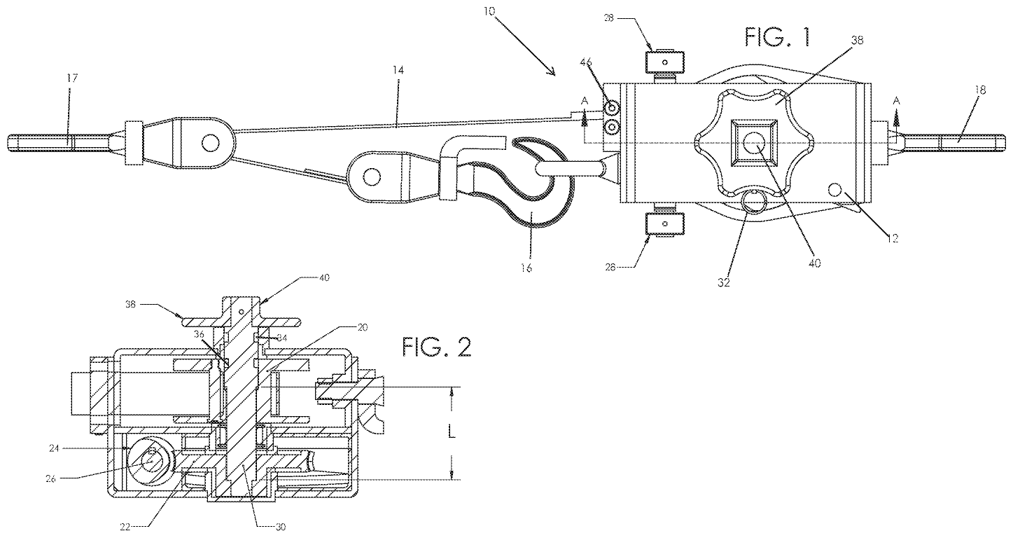

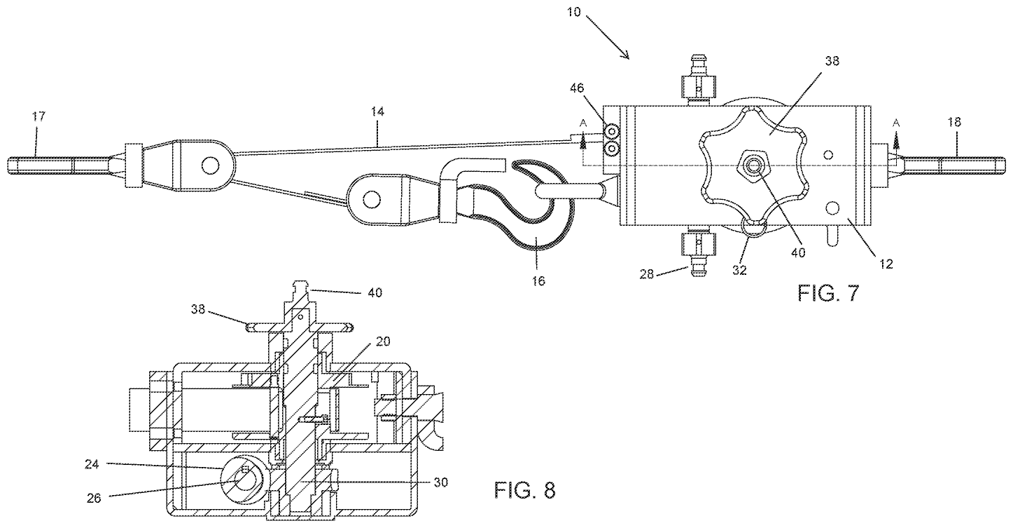

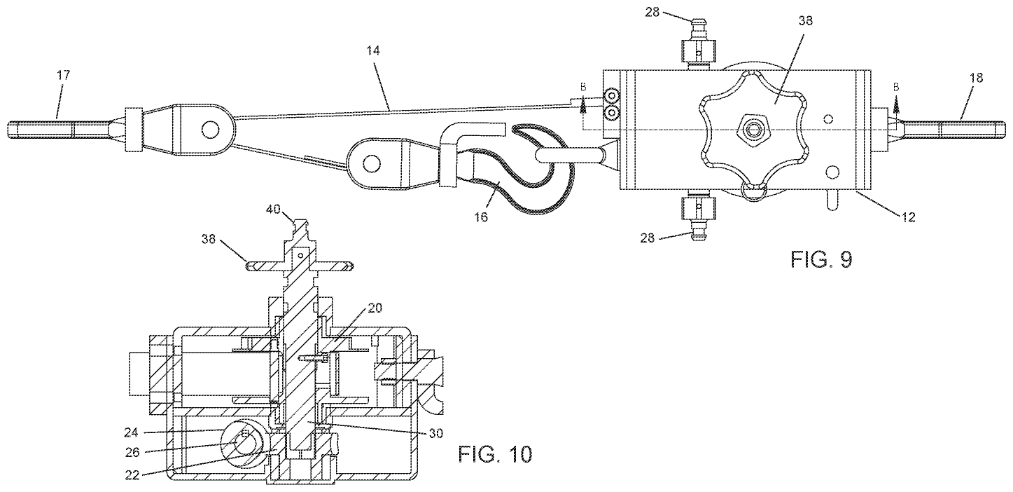

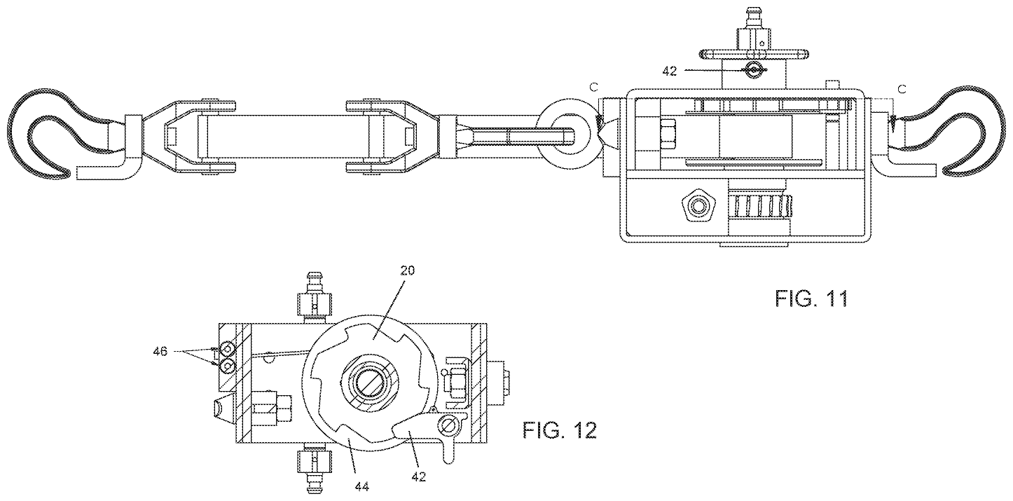

Referring to FIGS. 1 through 12, the present invention includes an improved cable tensioning device 10, according to an example embodiment of the disclosure. The components and arrangements shown in FIGS. 1 through 12 are not intended to limit the disclosed embodiments as the components used to implement the disclosed processes and features may vary. In accordance with disclosed embodiments, cable tensioning device 10 may include a frame 12, a drum 20, a moveable shaft 30, a circumferential gear 22, a worm gear 24, an input shaft 26, attachment pieces 28, a rope or strap 14, a rear hook assembly 18, a front hook assembly 16, and mid-point hook assembly 17. Mid-point hook assembly 17 may be configured to connect the device 10 with a cable or other device to be tensioned. The front hook assembly 16 is attached to the frame 12 in order to create a loop.

As previously discussed, cable tensioning device 10 may be configured to allow for safely positioning, pulling and tensioning items such as overhead utility cables. For example, when force is applied to one of the attachment pieces 28 (e.g., through the use of a hand crank or a powered device such as a drill), the attachment piece 28 rotates causing the input shaft 26 to rotate, causing the worm gear 24 to rotate. The rotation of the worm gear 24 causes the circumferential gear 22 to rotate causing the moveable shaft 30, and ultimately the drum 20 to rotate. As the drum 20 rotates, it will either roll up or roll out the attached rope or strap 14 depending on the direction of rotation. The rope or strap 14 may be fed through the frame 12 via strap guide rollers 46.

In some embodiments, the frame 12 may be made of aluminum. One of skill would appreciate that such an embodiment would help reduce the weight of the device 10. Additionally, one of skill would appreciate that any suitable material can be utilized for the construction of the frame 12.

In some embodiments, input shaft 26 may be equipped with a safety pin which allows for the disengagement of input force (e.g., cranking mechanism). In some embodiments, the safety pin may be manually operated. In other embodiments, the safety pin may be implemented using digital electronics and may be configured to automatically detected certain system characteristics. In other embodiments, the safety pin may cause disengagement of the attachment piece 28 with the input shaft 26 whenever a safe load handling rating of the tensioning device 10 is exceeded.

FIGS. 1, 2 and 7, 8 illustrate the moveable shaft 30 in an engaged position with the circumferential gear 22. The moveable shaft 30 includes a length (L) having the shape that fits within the matching bores of the circumferential gear 22 and the drum 20. The spring-loaded pin 32 is disposed within a first slot 34 of the moveable shaft 30, which prevents the moveable shaft 30 from being disengaged with circumferential gear 22. When the moveable shaft 30 is in the engaged position, the worm gear 24 and drum 20 are rotationally locked together and the drum 20 will not rotate until the worm gear 24 is rotated via the input shaft 26.

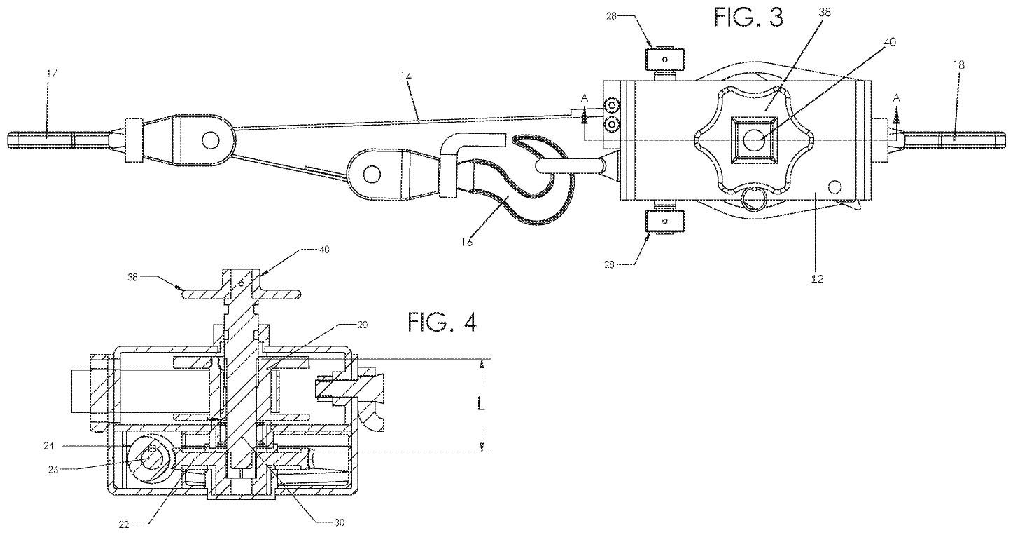

FIGS. 3, 4 and 9, 10 illustrate the moveable shaft 30 in a disengaged position with the circumferential gear 22. The spring-loaded pin 32 is removed from the first slot 34, the moveable shaft 30 is pulled away from the circumferential gear 22 such that the length (L) is no longer within the bore of the circumferential gear 22. The spring-loaded pin 32 is then released into a second slot 36 of the moveable shaft 30, which prevents the moveable shaft 30 from sliding back into the engaged position.

Once the user is ready to use the cable tensioning device 10, they may need to quickly take up a lot of slack in the rope or strap 14 before applying any load to the equipment being tensioned. To do so, the moveable shaft 30 is disengaged from the circumferential gear 22, as described above, to allow the drum 20 to spin freely. A hand wheel 38 that may be attached to an end of the moveable shaft 30 allows the user to quickly take up slack in the rope or strap 14 by manual rotation. The end of the moveable shaft 30 may also include an attachment piece 40 which may be the same shape and dimensions as the attachment pieces 28 of the input shaft 26. The attachment piece 40 of the moveable shaft 30 allows a user to partially tension the device 10 using a hand or powered crank.

While in the disengaged position, the rotation of the moveable shaft 30 and the rotation of the drum 20 are at a 1:1 ratio, meaning that in this partial tensioning position there is no gearing or other mechanical advantage. The user may partially tension the device 10 using the hand wheel 38 until it becomes too difficult to continue. The advantage of the direct drive hand cranking is that it is a fast way to take up a lot of slack and partially tension the device 10. Once the user is no longer able to add tension via the hand wheel 38 or hand crank, the moveable shaft 30 may be converted back to an engaged position by removing the spring-loaded pin 32 from the second slot 36, pushing the length (L) of the moveable shaft 30 back into the circumferential gear 22, and releasing the spring-loaded pin 32 back into the first slot 34. The user can then attach the hand crank to one of the attachment pieces 28 of the input shaft 26. By doing this, the user is then able to fully tension the device 10 using the mechanical advantage that the worm gear 24 provides.

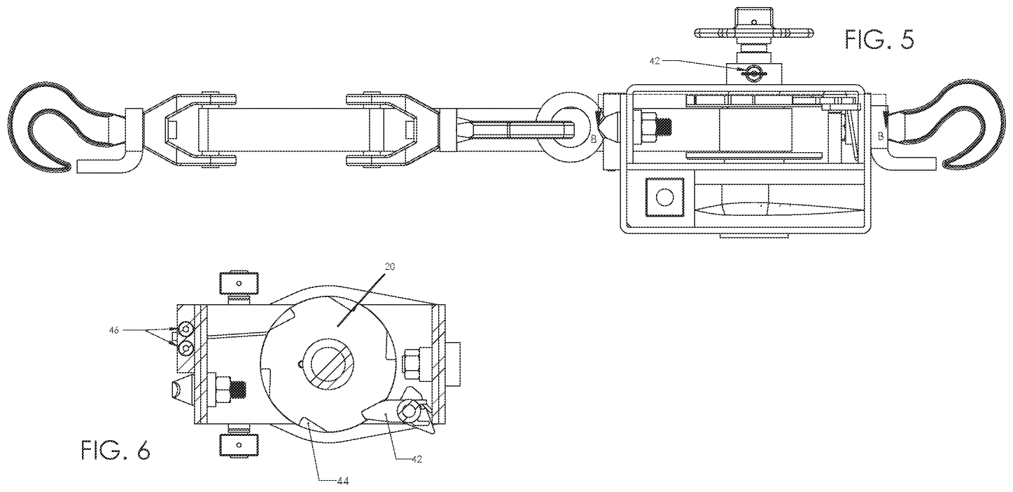

Referring to FIGS. 5, 6 and 11, 12, to prevent the drum 20 from spinning backwards when taking up slack or partially tensioning while the moveable shaft 30 is in the disengaged position, the present invention may utilize a spring-loaded pawl 42. The spring-loaded pawl 42 can be activated to engage notches 44 that are circumferentially disposed about the drum 20 to prevent backward rotation. The notches 44 on the drum 20 are configured such that the number of stop positions on the drum 20 match the same number and location of stop positions of the moveable shaft 30. The pawl 42 and the notches 44 rotationally match the drive feature in the moveable shaft 30 (hex, spline, square, or other) to enable the pawl 42 to hold the partial tension provided via the hand wheel 38. Since the pawl 42 is holding the pressure, the moveable shaft 30 is free to move to engage and disengage the circumferential gear 22 as needed.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. (canceled)

2. (canceled)

3. (canceled)

4. A device, comprising:
a shaft rotatably coupled to a drum to apply tension to a member;
a gear system adjacent the drum;
a first rotational input operatively associated with the shaft;
a second rotational input operatively associated with the gear system, the shaft movable between a disengaged position and an engaged position, wherein the engaged position prevents the drum from rotating by way of the first rotational input.

5. The device of claim 4, wherein the drum, the gear system, and the shaft share an axis of rotation.

6. The device of claim 4, wherein the disengaged position prevents the drum from rotating by way of the second rotational input.

7. The device of claim 4, wherein the engaged position the shaft is disposed in a bore shared by the drum and the gear system.

8. The device of claim 4, wherein the disengaged position the shaft disengages the gear system.

9. The device of claim 4, wherein the gear system comprises:
a circumferential gear sharing a bore with the drum; and
a gear providing mechanical advantage, wherein the second rotational input is coupled to said gear.

10. The device of claim 9, wherein said gear is a worm gear.

11. The device of claim 4, wherein the disengaged position a rotation of the shaft and a rotation of the drum are at a 1:1 ratio.

12. The device of claim 4, wherein the first rotational input includes a manual rotational source.

13. The device of claim 12, wherein the manual rotational source is a hand crank.

14. The device of claim 4, further comprising a locking pin for the disengaged position and for the engaged position.

15. The device of claim 4, further comprising:
a plurality of notches circumferentially disposed along the drum; and
a pawl urged to engage each of the plurality of notches to prevent the drum from spinning in a backward in the disengaged position.

16. A device, comprising:
a shaft rotatably coupled to a drum to apply tension to a member;
a gear system sharing a bore with the drum, wherein the drum, the gear system, and the shaft share an axis of rotation;
a first rotational input operatively associated with the shaft;
a second rotational input operatively associated with the gear system,
the shaft movable between a disengaged position and an engaged position, wherein the engaged position prevents the drum from rotating by way of the first rotational input, wherein the disengaged position prevents the drum from rotating by way of the second rotational input, wherein the engaged position the shaft is disposed in said bore.

17. The device of claim 16, wherein the gear system comprises:
a circumferential gear sharing the bore with the drum; and
a worm gear operatively associated with the circumferential gear, wherein the second rotational input is coupled to the worm gear.

18. The device of claim 17, wherein the disengaged position a rotation of the shaft and a rotation of the drum are at a 1:1 ratio.

19. The device of claim 17, wherein the first rotational input includes a manual rotational source.

20. The device of claim 16, further comprising a locking pin for the disengaged position and for the engaged position.

21. The device of claim 16, further comprising:
a plurality of notches circumferentially disposed along the drum; and
a pawl urged to engage each of the plurality of notches to prevent the drum from spinning in a backward rotation in the disengaged position.

22. A method for tensioning a member at two different ratios of rotation, the method comprising:
providing the device of claim 4;
attaching the member to the drum;
applying a first rotational energy to the first rotational input;
moving the shaft to the engaged position; and
applying a second rotational energy to the second rotational input.
